(19) United States
(12) Patent Application Publication
(10) Pub. No.: US 2023/0093801 A1
(43) Pub. Date: Mar. 30, 2023

(54) RECHARGEABLE LITHIUM BATTERY

(71) Applicant: SAMSUNG SDI CO., LTD., Yongin-si, Gyeonggi-do (KR)

(72) Inventors: Injun PARK, Yongin-si (KR); Myunghoon KIM, Yongin-si (KR); Sanghoon KIM, Yongin-si (KR); Yunhee KIM, Yongin-si (KR); Hongryeol PARK, Yongin-si (KR); Jeongmin SHIN, Yongin-si (KR); Seungryong OH, Yongin-si (KR); Myunghwan JEONG, Yongin-si (KR); Hyunbong CHOI, Yongin-si (KR)

(21) Appl. No.: 17/892,994

(22) Filed: Aug. 22, 2022

(30) Foreign Application Priority Data
Aug. 26, 2021 (KR) 10-2021-0113345

(51) Int. Cl. H01M 10/0567; H01M 10/0525; H01M 4/525; H01M 4/505; H01M 4/485; H01M 4/58; H01M 4/62

(52) U.S. Cl. CPC H01M 10/0567; H01M 10/0525; H01M 4/525; H01M 4/505; H01M 4/485; H01M 4/5825; H01M 4/625; H01M 2004/028

(57) ABSTRACT

A rechargeable lithium battery includes a positive electrode including a positive active material layer; a negative electrode including a negative active material layer;

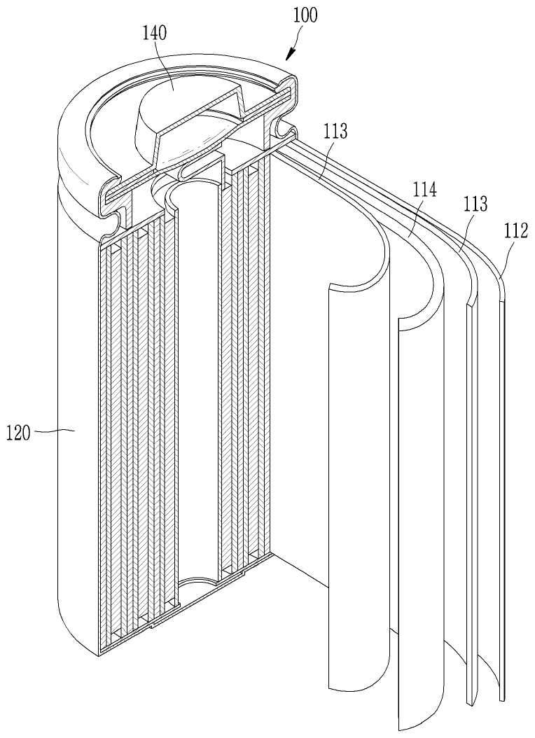

and an electrolyte solution including a non-aqueous organic solvent, a lithium salt, and an additive, wherein the positive active material layer includes a positive active material and carbon nanotubes, the carbon nanotubes are greater than about 0.1 wt % and less than about 3.0 wt % in amount based on a total weight of the positive active material layer, and the additive includes a compound represented by Chemical Formula 1.

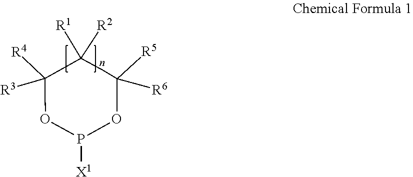

Details of Chemical Formula 1 are as described in the specification.

### CROSS-REFERENCE TO RELATED APPLICATION

This application claims priority to and the benefit of Korean Patent Application No. 10-2021-0113345, filed in the Korean Intellectual Property Office on Aug. 26, 2021, the entire content of which is incorporated herein by reference.

### BACKGROUND

### 1. Field

This disclosure relates to a rechargeable lithium battery.

### 2. Description of the Related Art

A rechargeable lithium battery may be recharged and may have an energy density per unit weight as high as three or more times that of a related art lead storage (or lead acid) battery, nickel-cadmium battery, nickel hydrogen battery, nickel zinc battery and/or the like. It may also be charged at a high charging rate and thus, may be suitable (e.g., commercially manufactured) for a laptop, a cell phone, an electric tool, an electric bike, and/or the like. Researches, e.g., on improvement of energy density, have been actively conducted.

For example, as information technology (IT) devices increasingly (e.g., continuously) achieve higher performance, a high-capacity battery is desired or required. While the high capacity may be realized through expansion of a voltage range, increasing the energy density may cause a problem of deteriorating performance of a positive electrode due to oxidization of an electrolyte solution in the high voltage range.

For example, LiPF₆, which is commonly (e.g., most often) utilized as a lithium salt of the electrolyte solution, may react with an electrolyte solvent to promote (or cause) depletion of the solvent and generate a large amount of gas. LiPF₆ may be decomposed and produce a decomposition product such as HF, PF₅, and/or the like, which may cause the electrolyte depletion and lead to performance deterioration and insufficient safety at a high temperature.

The decomposition products of the electrolyte solution may be deposited as a film on the surface of an electrode to increase internal resistance of the battery and eventually may cause problems of deteriorated battery performance and shortened cycle-life. In addition, this side reaction is further accelerated at a high temperature where the reaction rate becomes faster, and gas components generated due to the side reaction may cause a rapid increase of an internal pressure of the battery and thus may have a strong adverse effect on the stability of the battery.

Oxidization of the electrolyte solution is accelerated (e.g., greatly accelerated) in the high voltage range and thus is known to greatly increase the resistance of the electrode during the long-term charge and discharge process.

Accordingly, there is a need for an electrolyte solution suitable for usage under conditions of a high voltage and a high temperature.

### SUMMARY

Aspects according to one or more embodiments are directed toward a rechargeable lithium battery with improved battery stability (by suppressing decomposition of an electrolyte solution and a side reaction with an electrode) and simultaneously or concurrently, with improved initial resistance and storage characteristics at a high temperature (by improving impregnation of the electrolyte solution in a positive electrode).

Additional aspects will be set forth in part in the description which follows and, in part, will be apparent from the description, or may be learned by practice of the presented embodiments of the disclosure.

According to an embodiment of the present disclosure, a rechargeable lithium battery includes a positive electrode including a positive active material layer; a negative electrode including a negative active material layer; and an electrolyte solution including a non-aqueous organic solvent, a lithium salt, and an additive,

wherein the positive active material layer includes a positive active material and carbon nanotubes,

the carbon nanotubes are greater than about 0.1 wt % and less than about 3.0 wt % in amount based on a total weight of the positive active material layer, and

the additive includes a compound represented by Chemical Formula 1.

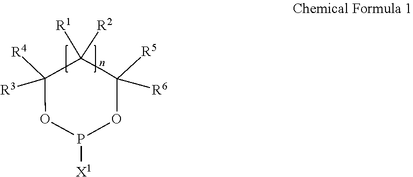

In Chemical Formula 1,

X¹ is a fluoro group (—F), a chloro group (—Cl), a bromo group (—Br), or an iodo group (—I),

R¹ to R⁶ are each independently hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and

n is 0 or 1.

The compound represented by Chemical Formula 1 may be represented by Chemical Formula 1A or Chemical Formula 1B.

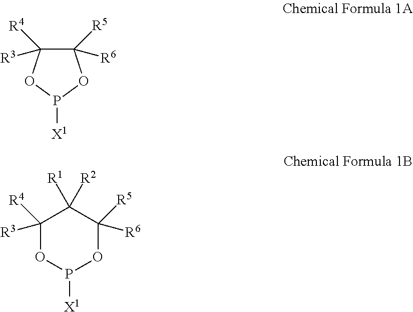

In Chemical Formula 1A and Chemical Formula 1B,

X¹ is a fluoro group (—F), a chloro group (—Cl), a bromo group (—Br), or an iodo group (—I), and

R¹ to R⁶ are each independently hydrogen, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

In Chemical Formula 1A and Chemical Formula 1B, R³ and R⁴ may each be hydrogen, and at least one selected from among R¹, R², R⁵, and R⁶ may be a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

The compound represented by Chemical Formula 1 may be at least one selected from the compounds of Group 1.

### Group 1

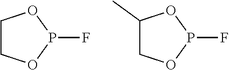

The compound represented by Chemical Formula 1 may be greater than about 0.2 parts by weight and less than about 2.0 parts by weight based on a total of 100 parts by weight of the electrolyte solution.

The additive may further include at least one other additive selected from among vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propene sultone (PST), propane sultone (PS), lithium tetrafluoroborate (LiBF₄), lithium difluorophosphate (LiPO₂F₂), and 2-fluoro biphenyl (2-FBP).

An average length of the carbon nanotubes may be greater than or equal to about 5 μm and less than about 200 μm.

The average length of the carbon nanotubes may be about 5 μm to about 100 μm.

The positive active material may be at least one lithium composite oxide represented by Chemical Formula 2.

LiₓM¹_{1-y-z-w}M²_{y}M³_{z}M⁴_{w}(PO₄)₁₋ₜ(O₂)ₜ Chemical Formula 2

In Chemical Formula 2,

0.5≤x<1.8, 0≤y≤1.0, 0≤z≤1.0, 0<y+z+w≤1.0, 0≤t≤1.0, 0≤w≤1.0, M¹ to M³ are each independently Ni, Co, Mn, Fe, Al, Sr, La, or a combination thereof, and M⁴ is Ti, Mg, Zr, Ca, Nb, P, F, B, or a combination thereof.

For example, the at least one lithium composite oxide may be represented by at least one of Chemical Formula 2-1 to Chemical Formula 2-4.

Liₓ₁Ni_{1-y1-z1}Co_{y1}M³_{z1}M⁴_{w1}O₂ Chemical Formula 2-1

In Chemical Formula 2-1,

M³ is Mn, Al, or a combination thereof,

M⁴ is Ti, Mg, Zr, Ca, Nb, P, F, B, or a combination thereof, and

0.9≤x1<1.2, 0≤y1≤0.2, 0<z1≤0.3, 0<y1+z1≤0.5, and 0≤w1≤0.1.

Liₓ₂MnM⁴_{w2}O₂ Chemical Formula 2-2

In Chemical Formula 2-2,

0.9≤x2<1.2, 0≤w2≤1.0, and M⁴ is Ti, Mg, Zr, Ca, Nb, P, F, B, or a combination thereof.

Liₓ₃CoM⁴_{w3}O₂ Chemical Formula 2-3

In Chemical Formula 2-3,

M⁴ is Ti, Mg, Zr, Ca, Nb, P, F, B, or a combination thereof, and

0.5<x3≤1, and 0≤w3≤0.1.

Liₓ₄Fe_{1-z4}M³_{z4}M⁴_{w4}PO₄ Chemical Formula 2-4

In Chemical Formula 2-4,

M³ is Co, Ni, or a combination thereof,

M⁴ is Ti, Mg, Zr, Ca, Nb, P, F, B, or a combination thereof, and

0.9≤x4≤1.8, 0≤z4≤0.3, and 0≤w4≤0.1.

A rechargeable lithium battery with improved initial resistance and high-temperature storage characteristics may be achieved (e.g., implemented) by suppressing an increase in the internal resistance of the battery.

### BRIEF DESCRIPTION OF THE DRAWING

The drawing is a schematic view illustrating a rechargeable lithium battery according to an embodiment of the present disclosure.

### DETAILED DESCRIPTION

Hereinafter, a rechargeable lithium battery according to embodiments of the present disclosure will be described in more detail with reference to the accompanying drawing. However, these embodiments are examples, and the present disclosure is not limited thereto and the present disclosure is defined by the scope of claims, and equivalents thereof.

Hereinafter, when a definition is not otherwise provided, “substituted” refers to replacement of hydrogen of a compound by a substituent selected from a halogen atom (F, Br, Cl, or I), a hydroxy group, an alkoxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid group or a salt thereof, a C1 to C20 alkyl group, a C2 to C20 alkenyl group, a C2 to C20 alkynyl group, a C6 to C30 aryl group, a C7 to C30 arylalkyl group, a C1 to C4 alkoxy group, a C1 to C20 heteroalkyl group, a C3 to C20 heteroarylalkyl group, a C3 to C30 cycloalkyl group, a C3 to C15 cycloalkenyl group, a C6 to C15 cycloalkynyl group, a C2 to C20 heterocycloalkyl group, and a combination thereof.

A rechargeable lithium battery may be classified into a lithium ion battery, a lithium ion polymer battery, a lithium polymer battery, and/or the like, depending on the type(s) or kind(s) of a separator and an electrolyte, and may also be classified to be cylindrical, prismatic, coin-type or kind, pouch-type or kind, and/or the like, depending on the shape(s). In addition, a rechargeable lithium battery may be bulk type or kind, thin film type or kind, and/or the like, depending on the size(s). Structures and manufacturing methods for these batteries pertaining to this disclosure may be any suitable ones in the related art.

Herein, a cylindrical rechargeable lithium battery will be described as an example of the rechargeable lithium battery. The drawing schematically shows the structure of a rechargeable lithium battery according to an embodiment. Referring to the drawing, a rechargeable lithium battery 100 according to an embodiment includes a battery cell including a positive electrode 114, a negative electrode 112 facing the positive electrode 114, a separator 113 between the positive electrode 114 and the negative electrode 112, and an electrolyte solution impregnating the positive electrode 114, the negative electrode 112, and the separator 113, a battery case 120 housing the battery cell, and a sealing member 140 sealing the battery case 120.

Hereinafter, a more detailed configuration of the rechargeable lithium battery 100 according to an embodiment of the present disclosure will be described.

A rechargeable lithium battery according to an embodiment of the present disclosure includes a positive electrode, a negative electrode, and an electrolyte solution.

The electrolyte solution includes a non-aqueous organic solvent, a lithium salt, and an additive, and the additive includes a compound represented by Chemical Formula 1.

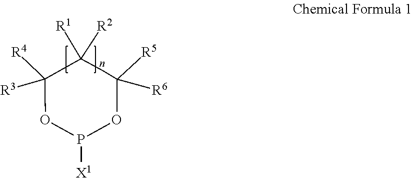

In Chemical Formula 1,

X¹ is a fluoro group (—F), a chloro group (—Cl), a bromo group (—Br), or an iodo group (—I),

R¹ to R⁶ are each independently hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and

n is 0 or 1.

The compound represented by Chemical Formula 1 has suitable or high high-temperature stability on the surface of the negative electrode, forms a solid electrolyte interface (SEI) with suitable or excellent ion conductivity, and suppresses a side reaction of LiPF₆ by a functional group such as —PO₂X¹ (especially —PO₂F) to reduce the gas generation caused by a decomposition reaction of the electrolyte solution during high-temperature storage.

For example, the compound represented by Chemical Formula 1 may be coordinated with a pyrolyzed product of a lithium salt such as LiPF₆ or anions dissociated from the lithium salt and thus form a complex, and the complex formation may stabilize the pyrolyzed product of the lithium salt such as LiPF₆ or the anions dissociated from the lithium salt. Therefore, it may suppress an undesired side reaction of the anions with the electrolyte and prevent or reduce gas generation inside a rechargeable lithium battery and thus may greatly reduce a defect rate as well as improve cycle-life characteristics of the rechargeable lithium battery.

The compound represented by Chemical Formula 1 may be represented by Chemical Formula 1A or Chemical Formula 1B.

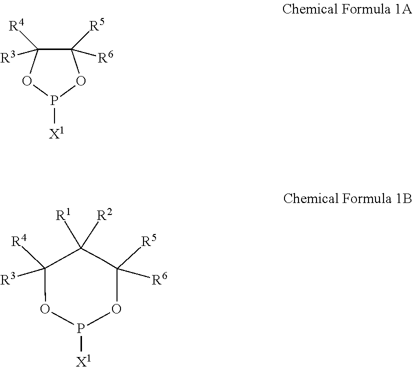

In Chemical Formula 1A and Chemical Formula 1B,

X¹ is a fluoro group (—F), a chloro group (—Cl), a bromo group (—Br), or an iodo group (—I),

R¹ to R⁶ are each independently hydrogen, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

In Chemical Formula 1A and Chemical Formula 1B, R³ and R⁴ may each be hydrogen, and at least one selected from among R¹, R², R⁵, and R⁶ may be a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

For example, the compound represented by Chemical Formula 1 may be represented by Chemical Formula 1A.

In a specific example, in Chemical Formula 1A, R³ and R⁴ may each be hydrogen and R⁵ and/or R⁶ may be a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

For example, in Chemical Formula 1A, R³ and R⁴ may each be hydrogen and R⁵ and/or R⁶ may be a substituted or unsubstituted C1 to C10 alkyl group.

The compound represented by Chemical Formula 1 may be included in an amount of greater than about 0.2 parts by weight and less than about 2.0 parts by weight, for example, about 0.3 parts by weight to about 1.5 parts by weight, or about 0.5 parts by weight to about 1.5 parts by weight, based on a total of 100 parts by weight of the electrolyte solution.

When the amount of the compound represented by Chemical Formula 1 is within the above ranges, a rechargeable lithium battery having improved storage characteristics at a high temperature and improved cycle-life characteristics can be obtained (e.g., implemented).

For example, the compound represented by Chemical Formula 1 may be selected from the compounds of Group 1, and may be, for example, 2-fluoro-1,3,2-dioxaphospholane and/or 2-fluoro-4-methyl-1,3,2-dioxaphospholane.

### Group 1

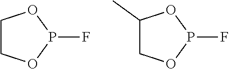

In some embodiments, the additive may further include other additive(s) in addition to the aforementioned additive.

The other additives may include at least one selected from among vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propene sultone (PST), propane sultone (PS), lithium tetrafluoroborate (LiBF₄), lithium difluorophosphate (LiPO₂F₂), and 2-fluorobiphenyl (2-FBP).

By further including the aforementioned other additives, cycle-life may be further improved and/or gases generated from the positive electrode and the negative electrode may be effectively controlled during high-temperature storage.

The other additives may be included in an amount of about 0.2 to 20 parts by weight, for example, about 0.2 to 15 parts by weight, or about 0.2 to 10 parts by weight based on the total weight of the electrolyte solution for a rechargeable lithium battery.

When the content of other additives is as described above, the increase in film resistance may be minimized or reduced, thereby contributing to the improvement of battery performance.

The non-aqueous organic solvent serves as a medium for transmitting ions taking part in the electrochemical reaction of a battery.

The non-aqueous organic solvent may be a carbonate-based, ester-based, ether-based, ketone-based, alcohol-based, and/or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, t-butyl acetate, methylpropionate, ethylpropionate, propylpropionate, decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. In addition, the ketone-based solvent may include cyclohexanone, and/or the like. The alcohol-based solvent may include ethanol, isopropyl alcohol, and/or the like and the aprotic solvent may include nitriles such as R-CN (wherein R is a hydrocarbon group having a C2 to C20 linear, branched, or cyclic structure and may include a double bond, an aromatic ring, or an ether bond), and/or the like, amides such as dimethyl formamide, and/or the like, dioxolanes such as 1,3-dioxolane, and/or the like, sulfolanes, and/or the like.

The non-aqueous organic solvent may be utilized alone or in a mixture, and when the organic solvent is utilized in a mixture, the mixing ratio may be controlled in accordance with a desirable battery performance.

The carbonate-based solvent may be prepared by mixing a cyclic carbonate and a linear carbonate. When the cyclic carbonate and linear carbonate are mixed together in a volume ratio of about 5:5 to about 1:9, an electrolyte performance may be improved.

In an embodiment, the non-aqueous organic solvent may include the cyclic carbonate and the linear carbonate in a volume ratio of about 5:5 to about 2:8, for example, the cyclic carbonate and the linear carbonate may be included in a volume ratio of about 4:6 to about 2:8.

In an embodiment, the cyclic carbonate and the linear carbonate may be included in a volume ratio of about 3:7 to about 2:8.

The non-aqueous organic solvent may further include an aromatic hydrocarbon-based organic solvent in addition to the carbonate-based solvent. Herein, the carbonate-based solvent and the aromatic hydrocarbon-based organic solvent may be mixed in a volume ratio of about 1:1 to about 30:1.

The aromatic hydrocarbon-based organic solvent may be an aromatic hydrocarbon-based compound represented by Chemical Formula 3.

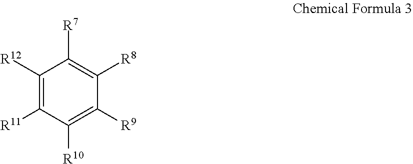

In Chemical Formula 3, R⁷ to R¹² are the same or different and are each independently selected from hydrogen, a halogen, a C1 to C10 alkyl group, a C1 to C10 haloalkyl group, and a combination thereof.

Examples of the aromatic hydrocarbon-based organic solvent may include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The lithium salt dissolved in the non-organic solvent supplies lithium ions in a battery, enables a basic operation of a rechargeable lithium battery, and improves transportation of the lithium ions between positive and negative electrodes. Examples of the lithium salt may include at least one supporting lithium salt selected from LiPF₆, LiBF₄, lithium difluoro(oxalato)borate (LiDFOB), LiPO₂F₂, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide, LiFSI), LiC₄F₉SO₃, LiClO₄, LiAlO₂, LiAlCl₄, LiN(CₓF₂ₓ₊₁SO₂)(C_{y}F_{2y+1}SO₂), (wherein, x and y are natural numbers, for example, an integer ranging from 1 to 20), LiCl, LiI, and LiB(C₂O₄)₂ (lithium bis(oxalato) borate, LiBOB). The lithium salt may be utilized in a concentration ranging from about 0.1 M to about 2.0 M. When the lithium salt is included at the above concentration range, an electrolyte may have suitable or excellent performance and lithium ion mobility due to optimal electrolyte conductivity and viscosity.

The positive electrode includes a positive electrode current collector and a positive active material layer on the positive electrode current collector, and the positive active material layer includes a positive active material and carbon nanotube (e.g., a plurality of carbon nanotubes). As used herein, the singular forms “a”, “an” and “the” are intended to include the plural forms as well, unless the context clearly indicates otherwise.

The carbon nanotubes may be included in an amount of greater than about 0.1 wt % and less than about 3.0 wt %, for example, greater than or equal to about 0.5 wt % and less than about 3.0 wt %, or greater than or equal to about 0.5 wt % and less than or equal to about 2 wt %, based on the total weight of the positive active material layer.

When the content of the carbon nanotube is within the above ranges, the amount of the dispersant for dispersing the carbon nanotubes may be adjusted to an appropriate amount, and an increase in resistance due to the increase in the amount of the dispersant may be alleviated, thereby preventing or reducing deterioration of battery performance.

An average length of the carbon nanotubes may be greater than or equal to about 5 μm and less than about 200 μm, for example, about 5 μm to about 100 μm, about 10 μm to about 100 μm, or about 50 μm to about 100 μm.

When the average length of the carbon nanotubes is within the above ranges, coating uniformity of the positive active material layer may be secured, thereby increasing impregnation of the electrode plate in the electrolyte solution to reduce the electrode plate resistance.

The average length of the carbon nanotubes refers to an average value of a maximum distance between two arbitrary ends of the plurality of carbon nanotubes.

The average length of carbon nanotubes in the present disclosure is an arithmetic average of the lengths of a plurality of carbon-based nanostructures. The average length of carbon nanotubes may be measured utilizing a field-radial scanning electron microscope. The carbon nanotube according to an embodiment of the present disclosure may be in a form including at least one selected from among a single-walled carbon nanotube, a double-walled carbon nanotube, and a multi-walled carbon nanotube. Among them, single-walled and/or double-walled carbon nanotubes may improve dispersibility of the slurry containing the carbon nanotubes, and may have suitable or excellent processability such as coating when forming the active material layer, and at the same time ensure suitable or excellent conductivity of the active material layer formed utilizing the same.

The positive active material may include lithiated intercalation compounds that reversibly intercalate and de-intercalate lithium ions.

For example, a composite oxide of a nickel-containing metal and lithium may be utilized.

Examples of the positive active material may include a compound represented by any one of the following chemical formulas.

LiₐA_{1-b}X_{b}D₂(0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O₂D_{c}(0.90≤a≤1.8, 0b 0.5, 0 c≤0.05); LiₐE_{2-b}X_{b}O_{4-c}D_{c} (0.90≤a≤1.8, 0≤b≤0.5, 0≤c≤0.05); LiₐNi_{1-b-c}Co_{b}X_{c}D_{α} (0.90≤a≤1.8, 0≤b≤0.5, 0≤c≤0.5, 0<α≤2); LiₐNi_{1-b-c}Co_{b}X_{c}O_{2-α}T_{α} (0.90≤a≤1.8, 0≤b≤0.5, 0≤c≤0.05, 0α≤2); 2); LiₐNi_{1-b-c}Co_{b}X_{c}O_{2-α}T₂ (0.90≤a≤1.8, 0≤b≤0.5, 0≤c≤0.05, 0<α<2); LiₐNi_{1-b-c}Mn_{b}X_{c}D_{α} (0.90≤a≤1.8, 0≤b≤0.5, 0≤c≤0.05, 0<α≤2); LiₐNi_{1-b-c}Mn_{b}X_{c}O_{2-α}T_{α}(0.90≤a≤1.8, 0≤b≤0.5, 0≤c≤0.05, 0<α<2); LiₐNi_{1-b-c}Mn_{b}X_{c}O_{2-α}T₂ (0.90≤a≤1.8, 0≤b≤0.5, 0≤c≤0.05, 0<α<2); LiₐNi_{b}E_{c}G_{d}O₂ (0.90≤a≤1.8, 0>b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃(0≤f≤2); Li_{(3-f)}Fe₂(PO₄)₃(0≤f≤2); LiₐFePO₄ (0.90≤a≤1.8)

In the above chemical formulas, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The compounds may have a coating layer on the surface thereof, or may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating process may include any suitable conventional processes as long as it does not cause any side effects on the properties of the positive active material (e.g., spray coating, dipping, etc.), which is well known to persons having ordinary skill in this art, so a detailed description thereof is not provided.

The positive active material may be, for example, at least one of lithium composite oxides represented by Chemical Formula 2.

LiₓM¹_{1-y-z-w}M²_{y}M³_{z}M⁴_{w}(PO₄)₁₋ₜ(O₂)ₜ Chemical Formula 2

In Chemical Formula 2,

0.5≤x<1.8, 0≤y≤1.0, 0≤z≤1.0, 0<y+z+w≤1.0, 0≤t≤1.0, 0≤w≤1.0, M¹ to M³ are each independently any one selected from metals such as Ni, Co, Mn, Fe, Al, Sr, La, and a combination thereof, and M⁴ is selected from Ti, Mg, Zr, Ca, Nb, P, F, B, and a combination thereof.

For example, the positive active material may be one or more lithium composite oxides represented by at least one of Chemical Formula 2-1 to Chemical Formula 2-4.

Liₓ₁Ni_{1-y1-z1}Co_{y1}M³_{z1}M⁴_{w1}O₂ Chemical Formula 2-1

In Chemical Formula 2-1,

M³ is Mn, Al, or a combination thereof,

M⁴ is Ti, Mg, Zr, Ca, Nb, P, F, B, or a combination thereof, and

0.9≤x1<1.2, 0≤y1≤0.2, 0<z1≤0.3, 0<y1+z1≤0.5, and 0≤w1≤0.1.

For example, the positive active material represented by Chemical Formula 2-1 may be LiNi_{0.88}Co_{0.105}Al_{0.015}O₂, LiNi_{0.91}Co_{0.075}Al_{0.015}O₂, LiNi_{0.94}Co_{0.45}Al_{0.015}O₂, LiNi_{0.88}Co_{0.105}Mn_{0.015}O₂, LiNi_{0.91}Co_{0.075}Mn_{0.015}O₂, or LiNi_{0.94}Co_{0.045}Mn_{0.015}O₂.

Liₓ₂MnM⁴_{w2}O₂ Chemical Formula 2-2

In Chemical Formula 2-2,

0.9≤x2≤1.2, 0≤w2≤1.0, and M⁴ is Ti, Mg, Zr, Ca, Nb, P, F, B, or a combination thereof.

For example, the positive active material represented by Chemical Formula 2-2 may be LiMnO₂.

Liₓ₃CoM⁴_{w3}O₂ Chemical Formula 2-3

In Chemical Formula 2-3,

M⁴ is Ti, Mg, Zr, Ca, Nb, P, F, B, or a combination thereof, and

0.5<x3≤1, and 0≤w3≤0.1.

For example, the positive active material represented by Chemical Formula 2-3 may be LiCoO₂.

Liₓ₄Fe_{1-z4}M³_{z4}M⁴_{w4}PO₄ Chemical Formula 2-4

In Chemical Formula 2-4,

M³ is Co, Ni, or a combination thereof,

M⁴ is Ti, Mg, Zr, Ca, Nb, P, F, B, or a combination thereof, and

0.9≤x4≤1.8, 0≤z4≤0.3, and 0≤w4≤0.1.

For example, the positive active material represented by Chemical Formula 2-4 may be LiFePO₄.

A content of the positive active material may be about 90 wt % to about 98 wt % based on the total weight of the positive active material layer.

In an embodiment of the present disclosure, the positive active material layer may include a binder. A content of the binder may be about 1 wt % to about 5 wt % based on the total weight of the positive active material layer.

The binder improves binding properties of positive active material particles with one another and with a current collector. Examples thereof may include (e.g., may be) polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but the present disclosure is not limited thereto.

Al may be utilized as the positive electrode current collector, but the present disclosure is not limited thereto.

The negative electrode includes a negative electrode current collector and a negative active material layer including a negative active material formed on the negative electrode current collector.

The negative active material may include a material that is capable of reversibly intercalates/de-intercalates lithium ions, a lithium metal, a lithium metal alloy, a material capable of doping/de-doping lithium, and/or a transition metal oxide.

The material that is capable of reversibly intercalates/de-intercalates lithium ions may be a carbon material which is any suitable generally-utilized carbon-based negative active material in a rechargeable battery and examples thereof may include (e.g., may be) crystalline carbon, amorphous carbon, or a combination thereof. Examples of the crystalline carbon may include (e.g., may be) graphite such as sheet-shape, flake, spherical shape, and/or fiber-shaped natural graphite and/or artificial graphite. Examples of the amorphous carbon may be soft carbon and/or hard carbon, a mesophase pitch carbonized product, calcined coke, and/or the like.

The lithium metal alloy may be an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping and de-doping lithium may be Si, a Si—C composite, SiOₓ (0<x<2), a Si—Q alloy (wherein Q is an element selected from an alkali metal, an alkaline-earth metal, a Group 13 element, a Group 14 element excluding Si, a Group 15 element, a Group 16 element, a transition metal, a rare earth element, and a combination thereof), Sn, SnO₂, and/or Sn—R (wherein R is an element selected from an alkali metal, an alkaline-earth metal, a Group 13 element, a Group 14 element excluding Sn, a Group 15 element, a Group 16 element, a transition metal, a rare earth element, and a combination thereof), and at least one thereof may be mixed with SiO₂. In some embodiments, the elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn (excluded for R), In, TI, Ge, P, As, Sb, Bi, S, Se, Te, Po, and a combination thereof.

The transition metal oxide may include vanadium oxide, lithium vanadium oxide, and/or lithium titanium oxide.

The negative active material according to an embodiment may be graphite or may include a Si composite and graphite together (e.g., a mixture of a Si composite and graphite).

When the negative active material includes the Si composite and graphite together, the Si composite and graphite may be included in the form of a mixture, and the Si composite and graphite may be included in a weight ratio of about 1:99 to about 50:50. For example, the Si composite and graphite may be included in a weight ratio of about 3:97 to about 20:80.

The Si composite includes a core including one or more Si-based particles and an amorphous carbon coating layer. For example, the Si-based particles may include at least one selected from among Si particles, a Si—C composite, SiOx (0<x≤2), and a Si alloy. For example, the Si—C composite may include Si particles and crystalline carbon, and an amorphous carbon coating layer on the surface of the Si—C composite.

The Si-based particles may have an average particle diameter of about 50 nm to about 200 nm.

When the average particle diameter of the Si-based particles is within the above range, volume expansion during charging and discharging may be suppressed, and a break in a conductive path due to particle crushing during charging and discharging may be prevented or reduced.

The Si-based particles may be included in an amount of about 1 wt % to about 60 wt %, for example, about 3 wt % to about 60 wt %, based on the total weight of the negative active material.

The negative active material according to another embodiment may further include crystalline carbon together with the aforementioned Si—C composite (e.g., a mixture of a crystalline carbon and the aforementioned Si—C composite).

When the negative active material includes a Si—C composite and crystalline carbon together, the Si—C composite and crystalline carbon may be included in the form of a mixture, and in this case, the Si—C composite and crystalline carbon may be included in a weight ratio of about 1:99 to about 50:50. For example, the Si—C composite and crystalline carbon may be included in a weight ratio of about 5:95 to about 20:80.

The crystalline carbon may include, for example, graphite, such as natural graphite, artificial graphite, or a mixture thereof.

An average particle diameter of the crystalline carbon may be about 5 μm to about 30 μm.

In the present specification, the average particle diameter may be a particle size (D50) at 50% by volume in a cumulative size-distribution curve. For example, the average particle diameter may be, for example, a median diameter (D50) measured utilizing a laser diffraction particle diameter distribution meter.

The Si—C composite may further include a shell surrounding the surface of the Si—C composite, and the shell may include amorphous carbon.

The amorphous carbon may include soft carbon, hard carbon, a mesophase pitch carbonized product, calcined coke, or a mixture thereof.

The amorphous carbon may be included in an amount of about 1 part by weight to about 50 parts by weight, for example, about 5 parts by weight to about 50 parts by weight, or about 10 parts by weight to about 50 parts by weight based on 100 parts by weight of the carbon-based active material.

The amorphous carbon precursor may include a coal-based pitch, mesophase pitch, petroleum-based pitch, coal-based oil, petroleum-based heavy oil, or a polymer resin such as a phenol resin, a furan resin, or a polyimide resin.

In the negative active material layer, the negative active material may be included in an amount of about 95 wt % to about 99 wt % based on the total weight of the negative active material layer.

In an embodiment of the present disclosure, the negative active material layer includes a binder, and optionally a conductive material. In the negative active material layer, a content of the binder may be about 1 wt % to about 5 wt % based on the total weight of the negative active material layer. When the negative active material layer includes a conductive material, the negative active material layer includes about 90 wt % to about 98 wt % of the negative active material, about 1 wt % to about 5 wt % of the binder, and about 1 wt % to about 5 wt % of the conductive material.

The binder improves binding properties of negative active material particles with one another and with a current collector. The binder includes a non-water-soluble binder, a water-soluble binder, or a combination thereof.

The non-water-soluble binder may be selected from polyvinylchloride, carboxylated polyvinylchloride, polyvinylfluoride, polyurethane, polytetrafluoroethylene, polyvinylidene fluoride, polyethylene, polypropylene, polyamideimide, polyimide, and a combination thereof.

The water-soluble binder may be a rubber-based binder and/or a polymer resin binder. The rubber-based binder may be selected from a styrene-butadiene rubber, an acrylated styrene-butadiene rubber (SBR), an acrylonitrile-butadiene rubber, an acrylic rubber, a butyl rubber, a fluorine rubber, and a combination thereof. The polymer resin binder may be selected from polytetrafluoroethylene, ethylenepropylenecopolymer, polyethyleneoxide, polyvinylpyrrolidone, polyepichlorohydrine, polyphosphazene, polyacrylonitrile, polystyrene, an ethylenepropylenediene copolymer, polyvinylpyridine, chlorosulfonated polyethylene, latex, a polyester resin, an acrylic resin, a phenolic resin, an epoxy resin, polyvinyl alcohol, and a combination thereof.

When the water-soluble binder is utilized as a negative electrode binder, a cellulose-based compound may be further utilized to provide (e.g., modify) viscosity as a thickener. The cellulose-based compound includes one or more selected from among carboxymethyl cellulose, hydroxypropylmethyl cellulose, methyl cellulose, and alkali metal salts thereof. The alkali metals may be Na, K, and/or Li. Such a thickener may be included in an amount of about 0.1 parts by weight to about 3 parts by weight based on 100 parts by weight of the negative active material.

The conductive material is included to provide electrode conductivity and any suitable electrically conductive material may be utilized as a conductive material unless it causes a chemical change. Examples of the conductive material may include a carbon-based material such as natural graphite, artificial graphite, carbon black, acetylene black, ketjen black, a carbon fiber, and/or the like; a metal-based material of a metal powder and/or a metal fiber including copper, nickel, aluminum, silver, and/or the like; a conductive polymer such as a polyphenylene derivative; or a mixture thereof.

The negative current collector may be selected from a copper foil, a nickel foil, a stainless steel foil, a titanium foil, a nickel foam, a copper foam, a polymer substrate coated with a conductive metal, and a combination thereof.

A separator may exist (e.g., may be included) between the positive electrode and the negative electrode depending on the type or kind of the rechargeable lithium battery. Such a separator may include polyethylene, polypropylene, or polyvinylidene fluoride, or may include multi-layers thereof such as a polyethylene/polypropylene double-layered separator, a polyethylene/polypropylene/polyethylene triple-layered separator, or a polypropylene/polyethylene/polypropylene triple-layered separator.

Hereinafter, examples of the present disclosure and comparative examples are described. These examples, however, are not in any sense to be interpreted as limiting the scope of the present disclosure.

### Manufacture of Rechargeable Lithium Battery Cell

### EXAMPLE 1

LiNi_{0.88}Co_{0.105}Al_{0.015}O₂ as a positive active material, polyvinylidene fluoride as a binder, and carbon nanotubes (average length: 50 μm) as a conductive material were mixed in a weight ratio of 96:3:1, respectively, and were dispersed in N-methyl pyrrolidone to prepare a positive active material slurry.

The positive active material slurry was coated on a 15 μm-thick Al foil, dried at 100° C., and then pressed to prepare a positive electrode.

As a negative active material, a mixture of artificial graphite and a Si—C composite in a weight ratio of 93:7 was utilized, and the negative active material, a styrene-butadiene rubber binder, and carboxymethyl cellulose were mixed in a weight ratio of 98:1:1, respectively, and dispersed in distilled water to prepare a negative active material slurry.

The Si—C composite included a core including artificial graphite and silicon particles, and a coal-based pitch coating on the surface of the core.

The negative active material slurry was coated on a 10 μm-thick Cu foil, dried at 100° C., and then pressed to prepare a negative electrode.

An electrode assembly was prepared by assembling the prepared positive and negative electrodes and a polyethylene separator having a thickness of 25 μm, and an electrolyte solution was injected thereto to prepare a rechargeable lithium battery cell.

A composition of the electrolyte solution is as follows.

(Composition of Electrolyte Solution)

Salt: 1.5 M LiPF₆

Solvent: ethylene carbonate: ethylmethyl carbonate: dimethyl carbonate (EC:EMC:DMC=volume ratio of 20:10:70)

Additives: 0.75 parts by weight of 2-fluoro-4-methyl-1,3,2-dioxaphospholane/10 parts by weight of fluoroethylene carbonate (FEC)/0.5 parts by weight of succinonitrile (SN). That is, the additives include 0.75 parts by weight of 2-fluoro-4-methyl-1,3,2-dioxaphospholane as the additive according to embodiments of the present disclosure, and further include 10 parts by weight of fluoroethylene carbonate (FEC) and 0.5 parts by weight of succinonitrile (SN) as the other additives.

Herein, in the composition of electrolyte solution, the term “parts by weight” refers to the relative content of additives to 100 parts by weight of the total electrolyte solution (lithium salt+non-aqueous organic solvent).

### COMPARATIVE EXAMPLE 1

A rechargeable lithium battery cell was manufactured in substantially the same manner as in Example 1, except that an electrolyte solution containing no additive (2-fluoro-4-methyl-1,3,2-dioxaphospholane) was utilized.

### EXAMPLES 2 AND 3

Rechargeable lithium battery cells were manufactured in substantially the same manner as in Example 1, except that the content of the carbon nanotube was changed respectively into 0.5 wt % and 2.0 wt % to manufacture a positive electrode.

### COMPARATIVE EXAMPLES 2 AND 3

Rechargeable lithium battery cells were manufactured in substantially the same manner as in Example 1, except that the content of the carbon nanotube was changed respectively into 0.1 wt % and 3.0 wt % to manufacture a positive electrode.

### EXAMPLES 4 AND 5

Rechargeable lithium battery cells were manufactured in substantially the same manner as in Example 1, except that the content of the additive (2-fluoro-4-methyl-1,3,2-dioxaphospholane) was changed respectively into 0.5 parts by weight and 1.5 parts by weight to manufacture an electrolyte solution.

### COMPARATIVE EXAMPLES 4 AND 5

Rechargeable lithium battery cells were manufactured in substantially the same manner as in Example 1, except that the content of the additive (2-fluoro-4-methyl-1,3,2-dioxaphospholane) was changed respectively into 0.2 parts by weight and 2.0 parts by weight by weight to manufacture an electrolyte solution.

### EXAMPLES 6 AND 7

Rechargeable lithium battery cells were manufactured in substantially the same manner as in Example 1, except that the average length of the carbon nanotubes was changed respectively into 5 μm and 100 μm to manufacture a positive electrode.

### COMPARATIVE EXAMPLES 6 AND 7

Rechargeable lithium battery cells were manufactured in substantially the same manner as in Example 1, except that the average length of the carbon nanotubes was changed respectively into 1 μm and 200 μm to manufacture a positive electrode.

The rechargeable lithium battery cells were manufactured with the following compositions shown in Table 1.

TABLE 1

| | | | Composition of |
|---|---|---|---|
| | Composition of | | electrolyte solution |
| | positive electrode | | (content of |
| | Content of | Length of | 2-fluoro-4-methyl- |
| | CNT | CNT | 1,3,2-dioxaphospholane) |
| | (wt %) | (μm) | (parts by weight) |
| Comparative | 1.0 | 50 | — |
| Example 1 | | | |
| Example 1 | 1.0 | 50 | 0.75 |
| Comparative | 0.1 | 50 | 0.75 |
| Example 2 | | | |
| Comparative | 3.0 | 50 | 0.75 |
| Example 3 | | | |
| Example 2 | 0.5 | 50 | 0.75 |
| Example 3 | 2.0 | 50 | 0.75 |
| Comparative | 1.0 | 50 | 0.2 |
| Example 4 | | | |
| Comparative | 1.0 | 50 | 2.0 |
| Example 5 | | | |
| Example 4 | 1.0 | 50 | 0.5 |
| Example 5 | 1.0 | 50 | 1.5 |
| Comparative | 1.0 | 1.0 | 0.75 |
| Example 6 | | | |
| Comparative | 1.0 | 200 | 0.75 |
| Example 7 | | | |
| Example 6 | 1.0 | 5 | 0.75 |
| Example 7 | 1.0 | 100 | 0.75 |

### Evaluation 1: Impregnation Evaluation of Electrolyte Solution

The electrode assemblies according to Examples 1 to 7 and Comparative Examples 1 to 7 were each impregnated with (in) an electrolyte solution by injecting the electrolyte solution thereinto.

The electrolyte solution was prepared by utilizing a mixed solvent of EC/EMC/DMC (a volume ratio of 20/10/70) to prepare a 1.5 M LiPF₆ solution and adding 0 to 3 parts by weight of 2-fluoro-4-methyl-1,3,2-dioxaphospholane thereto.

An amount (impregnation amount) of the electrolyte solution impregnated per hour in the electrode assemblies was calculated according to Equation 1.

Impregnation amount=(Weight of electrode assembly after impregnating electrode assembly in electrolyte solution)−(Weight of initial electrode assembly) Equation 1

The results are as shown in Table 2.

Evaluation 2: Evaluation of DC Resistance Increase Rate after High-Temperature Storage

The lithium secondary battery cells according to Examples 1 to 7 and Comparative Examples 1 to 7 were measured with respect to initial DC resistance (DCIR) as ΔV/ΔI (change in voltage/change in current), and after setting a maximum energy state inside the cells to a fully charged state (SOC 100%), the cells were stored at a high temperature (60° C.) for 30 days and then, measured again with respect to DC resistance to calculate a DCIR increase rate (%) according to Equation 2, and the results are shown in Table 2.

DCIR increase rate=(DCIR after 30 days/initial DCIR)×100% Equation 2

### Evaluation 3: Evaluation of High-Temperature Cycle-Life Characteristics

The rechargeable lithium battery cells according to Examples 1 to 7 and Comparative Examples 1 to 7 were once charged and discharged at 0.2 C and then, measured with respect to charge and discharge capacity (before stored at a high temperature).

In addition, the rechargeable lithium battery cells according to Examples 1 to 7 and Comparative Examples 1 to 7 were charged at SOC 100% (a state of being charged to 100% of charge capacity when total charge capacity of a battery cell was 100%) and then, stored at 60° C. for 5 hours and initially charged and discharged at 0.5 C. Herein, charge and discharge characteristics of the cells were evaluated by measuring charge and discharge capacity and calculating a discharge capacity ratio of the 300^{th} discharge capacity to the first discharge capacity, and the retention (%) results are shown in Table 2.

TABLE 2

| | | High-temperature | |
|---|---|---|---|
| | | cycle-life | DCIR |
| | Impregnation | capacity retention | increase |
| | amount (g) | (%) | rate (%) |
| Comparative | 0.0139 | 83 | 135 |
| Example 1 | | | |
| Example 1 | 0.0218 | 89 | 119 |
| Comparative | 0.0142 | 83 | 135 |
| Example 2 | | | |
| Comparative | 0.0109 | 81 | 139 |
| Example 3 | | | |
| Example 2 | 0.0205 | 87 | 122 |
| Example 3 | 0.0172 | 86 | 128 |
| Comparative | 0.0113 | 81 | 142 |
| Example 4 | | | |
| Comparative | 0.0102 | 80 | 138 |
| Example 5 | | | |
| Example 4 | 0.0181 | 87 | 125 |
| Example 5 | 0.0161 | 85 | 127 |
| Comparative | 0.0125 | 82 | 140 |
| Example 6 | | | |
| Comparative | 0.0115 | 83 | 137 |
| Example 7 | | | |
| Example 6 | 0.0174 | 85 | 127 |
| Example 7 | 0.0197 | 88 | 123 |

Referring to Table 2, the rechargeable lithium battery cells according to the examples each had an impregnated electrolyte solution in a larger amount than the cells according to the comparative examples and thus exhibited improved high-temperature cycle-life characteristics and resistance characteristics after the high-temperature storage.

Accordingly, the rechargeable lithium battery cell according to an example embodiment of the present disclosure exhibited improved impregnation properties in an electrolyte solution and thus realized suitable or excellent cycle characteristics and in addition, exhibited reduced resistance after the high-temperature storage and thus improved high-temperature stability.

As used herein, the term “and/or” includes any and all combinations of one or more of the associated listed items. Throughout the disclosure, the expression, such as “at least one of a, b or c”, “at least one selected from a, b, and c”, “at least one selected from the group consisting of a, b, and c”, etc., indicates only a, only b, only c, both (e.g., simultaneously) a and b, both (e.g., simultaneously) a and c, both (e.g., simultaneously) b and c, all of a, b, and c, or variation(s) thereof.

The use of “may” when describing embodiments of the present disclosure refers to “one or more embodiments of the present disclosure”.

As used herein, the terms “substantially”, “about”, and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

While this disclosure has been described in connection with what is presently considered to be practical example embodiments, it is to be understood that the disclosure is not limited to the disclosed embodiments. On the contrary, it is intended to cover various modifications and equivalent arrangements included within the spirit and scope of the appended claims, and equivalents thereof.

### DESCRIPTION OF SYMBOLS

100: rechargeable lithium battery
112: negative electrode
113: separator
114: positive electrode
120: battery case
140: sealing member

What is claimed is:

1. A rechargeable lithium battery, comprising
a positive electrode comprising a positive active material layer;
a negative electrode comprising a negative active material layer; and
an electrolyte solution comprising a non-aqueous organic solvent, a lithium salt, and an additive,
wherein the positive active material layer comprises a positive active material and carbon nanotubes, and
the carbon nanotubes are greater than about 0.1 wt % and less than about 3.0 wt % in amount based on a total weight of the positive active material layer, and
the additive comprises a compound represented by Chemical Formula 1: 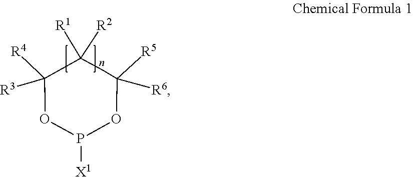
wherein, in Chemical Formula 1,
X¹ is a fluoro group (—F), a chloro group (—Cl), a bromo group (—Br), or an iodo group (—I),
R¹ to R⁶ are each independently hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and
n is 0 or 1.

2. The rechargeable lithium battery of claim 1, wherein
the compound represented by Chemical Formula 1 is represented by Chemical Formula 1A or Chemical Formula 1B: 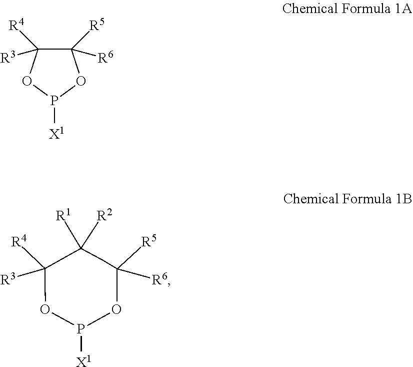
wherein, in Chemical Formula 1A and Chemical Formula 1B,
X¹ is a fluoro group (—F), a chloro group (—Cl), a bromo group (—Br), or an iodo group (—I), and
R¹ to R⁶ are each independently hydrogen, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

3. The rechargeable lithium battery of claim 2, wherein in Chemical Formula 1A and Chemical Formula 1B,
R³ and R⁴ are each hydrogen, and
at least one selected from among R¹, R², R⁵, and R⁶ is a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

4. The rechargeable lithium battery of claim 2, wherein
the compound represented by Chemical Formula 1 is at least one selected from compounds of Group 1:
Group 1

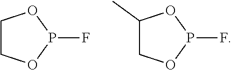

5. The rechargeable lithium battery of claim 1, wherein
the compound represented by Chemical Formula 1 is greater than about 0.2 parts by weight and less than about 2.0 parts by weight based on a total of 100 parts by weight of the electrolyte solution.

6. The rechargeable lithium battery of claim 1, wherein
the additive further includes at least one other additive selected from among vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propene sultone (PST), propane sultone (PS), lithium tetrafluoroborate (LiBF₄), lithium difluorophosphate (LiPO₂F₂), and 2-fluoro biphenyl (2-FBP).

7. The rechargeable lithium battery of claim 1, wherein
an average length of the carbon nanotubes is greater than or equal to about 5 μm and less than about 200 μm.

8. The rechargeable lithium battery of claim 1, wherein
an average length of the carbon nanotubes is about 5 μm to about 100 μm.

9. The rechargeable lithium battery of claim 1, wherein
the positive active material is at least one lithium composite oxide represented by Chemical Formula 2:
LiₓM¹_{1-y-z-w}M²_{y}M³_{z}M⁴_{w}(PO₄)₁₋ₜ(O₂)ₜ Chemical Formula 2
wherein, in Chemical Formula 2,
M¹ to M³ are each independently Ni, Co, Mn, Fe, Al, Sr, La, or a combination thereof,
M⁴ is Ti, Mg, Zr, Ca, Nb, P, F, B, or a combination thereof, and
0.5≤x<1.8, 0≤y≤1.0, 0≤z≤1.0, 0<y+z+w≤1.0, 0≤t≤1.0, and 0≤w≤1.0.

10. The rechargeable lithium battery of claim 9, wherein
the at least one lithium composite oxide is represented by at least one of Chemical Formula 2-1 to Chemical Formula 2-4:
Liₓ₁Ni_{1-y1-z1}Co_{y1}M³_{z1}M⁴_{w1}O₂ Chemical Formula 2-1
wherein, in Chemical Formula 2-1,
M³ is Mn, Al, or a combination thereof,
M⁴ is Ti, Mg, Zr, Ca, Nb, P, F, B, or a combination thereof, and
0.9≤x1<1.2, 0≤y1≤0.2, 0<z1≤0.3, 0≤y1+z1≤0.5, and 0≤w1≤0.1,
Liₓ₂MnM⁴_{w2}O₂ Chemical Formula 2-2
wherein, in Chemical Formula 2-2,
0.9≤x2<1.2, 0≤w2≤1.0, and
M⁴ is Ti, Mg, Zr, Ca, Nb, P, F, B, or a combination thereof,
Liₓ₃CoM⁴_{w3}O₂ Chemical Formula 2-3
wherein, in Chemical Formula 2-3,
M⁴ is Ti, Mg, Zr, Ca, Nb, P, F, B, or a combination thereof, and
0.5<x3≤1, and 0≤w3≤0.1,
Liₓ₄Fe_{1-z4}M³_{z4}M⁴_{w4}PO₄ Chemical Formula 2-4
wherein, in Chemical Formula 2-4,
M³ is Co, Ni, or a combination thereof,
M⁴ is Ti, Mg, Zr, Ca, Nb, P, F, B, or a combination thereof, and
0.9≤x4≤1.8, 0≤z4≤0.3, and 0≤w4≤0.1.
